(19) United States
(12) Patent Application Publication
(10) Pub. No.: US 2023/0091044 A1
(43) Pub. Date: Mar. 23, 2023

(54) DRONE COMMUNICATION AND CONTROL SYSTEM UTILIZING A MOBILE DRONE STATION AND A REMOTE PILOT CENTER

(71) Applicant: HyDaaS Inc., Englewood, NJ (US)

(72) Inventor: Steven KIM, Englewood, NJ (US)

(21) Appl. No.: 17/945,949

(22) Filed: Sep. 15, 2022

Related U.S. Application Data
(60) Provisional application No. 63/245,412, filed on Sep. 17, 2021.

(51) Int. Cl. B64C 39/02

(52) U.S. Cl. CPC B64C 39/024; B64C 2201/141; B64C 2201/146; B64C 2201/208; B64C 2201/123

(57) ABSTRACT

A drone communication and control system which utilized a mobile drone station which has capabilities of fueling hydrogen or liquid hydrogen drone, a communication control unit between the drone and the mobile drone station, a communication unit between the remote pilot center and the mobile station, the edge computing system for analyzing the images which are taken from the drone in a real time.

### CROSS-REFERENCE TO RELATED APPLICATION

This application claims priority to U.S. Provisional Patent Application No. 63/245,412, filed on Sep. 17, 2021, which is hereby incorporated by reference in its entirety.

### BACKGROUND

### Field of the Disclosure

The present disclosure relates to a drone communication and control system for a mobile drone and a remote pilot center.

### Description of the Background

A drone has been rapidly utilized in various industrial applications such as filming & photography, inspection & maintenance, precision agriculture, mapping & surveying and surveillance & monitoring, etc. Under the Federal Aviation Administration (FAA) regulatory, there is a weight limitation for the drone, and a weight lighter than 55 pounds is categorized as a small drone which has a relatively low regulatory restriction for visible line of sight operation of the drone under the FAA Part 107 rule.

There are demands for a beyond visible line of sight (BVLOS) autonomous operation of the drone especially for the large area applications where the drone shall fly beyond line of sight from the human operator. Although, FAA recently issued a highly limited permit for the BVLOS autonomous remote piloting, however, assuring the safety is a key concern for the BVLOS autonomous remote piloting of the drone.

A hydrogen fuel cell powered drone has for more than 120 minutes of flying time which extends the drone coverage for more than 20 km in diameters, a visible line of sight operation of the drone according to the FAA Part 107 rule will be difficult for the human operator.

### SUMMARY

The present disclosure is directed to a drone communication and control for a mobile drone station and a remote pilot center that substantially obviates one or more of problems due to limitations and disadvantages of the prior art.

More specifically, the present disclosure is to provide an operational solution for a human operator control the drone within a visible line of sight utilizing a mobile and a remote pilot center

Additional features and advantages of the disclosure will be set forth in the description which follows and in part will be apparent from the description, or may be learned by practice of the disclosure. Other advantages of the present disclosure will be realized and attained by the structure particularly pointed out in the written description and claims hereof as well as the appended drawings.

To achieve these and other advantages and in accordance with the present disclosure, as embodied and broadly described, a drone communication and control system for a mobile drone station and a remote pilot center, comprise a mobile drone station configured to control a drone by using a private WIFI; a remote pilot center configured to control the mobile drone station by using a commercial wireless network; a remote pilot center configured to set a drone navigation plan to a local authority of a drone traffic management authority; and an edge computing system configured to analyze images taken by the drone in a real time.

The drone navigation plan in the communication and control system includes a flight routing, an altitude and a flying time.

The remote pilot center in the communication and control system configured to maintain the mobile drone station within a distance from the drone within a visible line of sight.

It is to be understood that both the foregoing general description and the following detailed description are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of the disclosure, illustrate aspects of the disclosure and together with the description serve to explain the principle of the disclosure. This patent or application file contains at least one drawing executed in color. Copies of this patent or patent application publication with color drawings will be provided by the U.S. Patent and Trademark Office upon request and payment of the necessary fee.

In the drawings:

FIG. 1 is a schematic view for a drone communication and control system according to the present disclosure;

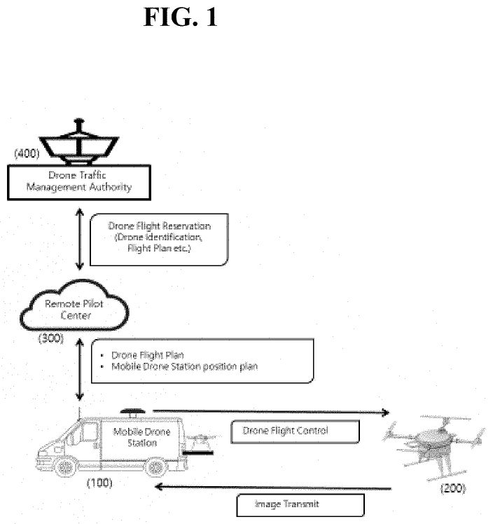

FIG. 2 is a view showing a drone inspection path over a wide range (more than 5 km) with a mobile drone station following a drone within a visible line of sight; and

FIG. 3 is a view showing a drone inspection for valley structure with a mobile drone station following a drone within a visible line of sight.

### DETAILED DESCRIPTION

Reference will now be made in detail to the aspects of the present disclosure, examples of which are illustrated in the accompanying drawings. Wherever possible, the same reference numbers will be used throughout the drawings to refer to the same or like parts.

The present disclosure is to provide a hydrogen drone has a speed of about 40 km/hour and the flying time of 120 minutes is enable for drone to cover 30 km radius region which is well beyond the visible line of sight. The visible distance is 11 km if the drone flies at an altitude of 10 meters high. Thus, in order to ensure the safety and satisfy the FAA Part 107 regulatory, the operator shall be able to maintain a visible line of sight from the drone.

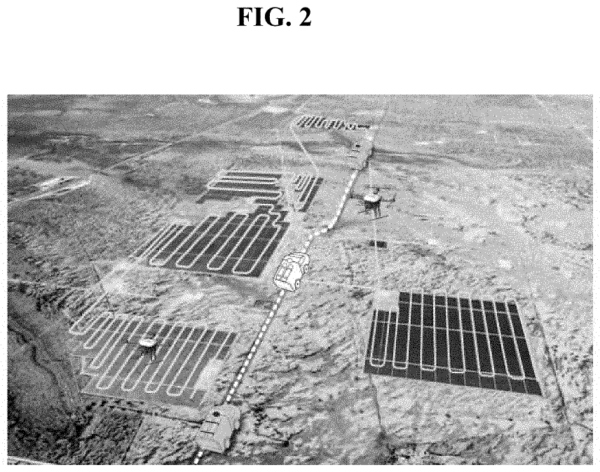

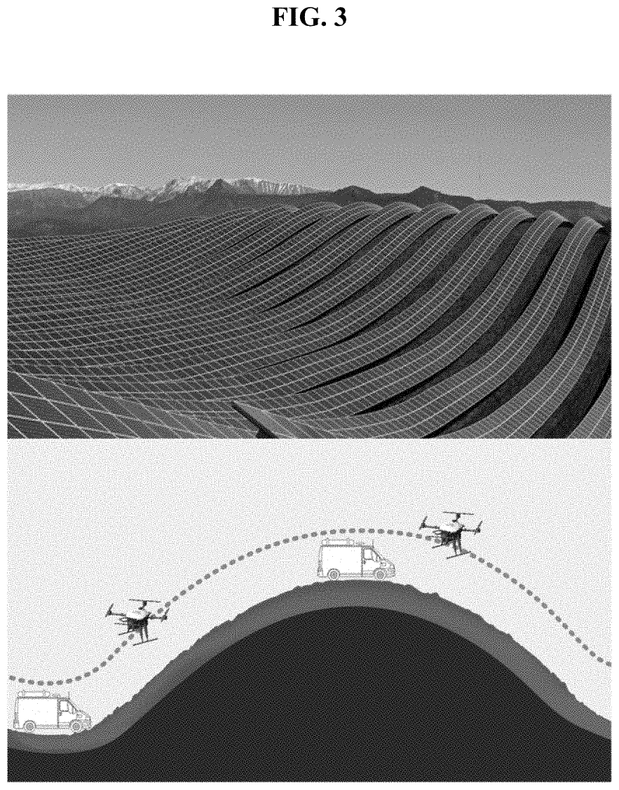

In order to ensure the safety, the mobile drone station (100) shall be positioned by maintaining a distance within a visible line of sight distance from the drone (200) as shown in FIGS. 2 and 3.

More specifically, a remote pilot center (300) is configuring a drone flight plan as well as a mobile drone station routing plan and then a remote pilot center (300) shall do the necessary drone flight reservation process to the local drone traffic management authority (400). The remote pilot center (300) is configuring the drone flight plan and a routing plan of the mobile drone station (100) in order to ensure the hydrogen drone (200) within visible line of sight by maintaining a proper distance as shown in FIGS. 2 and 3.

A mobile drone station (100) is equipped with a private WIFI base station for the drone, which will also provide a further safety assurance of the drone. The private WIFI at mobile drone station will be able to maintain a good communication and control between the drone and the mobile drone station because the commercial local communication signal can be interrupted temporarily when the drone is flying in a low communication signal region.

It will be apparent to those skilled in the art that various modifications and variations can be made in the mobile drone communication and control station of the present disclosure without departing from the spirit or scope of the aspects. Thus, it is intended that the present disclosure covers the modifications and variations of the aspects provided they come within the scope of the appended claims and their equivalents.

What is claimed is:

1. A drone communication and control system, comprising:
a mobile drone station configured to control a drone by using a private WIFI;
a remote pilot center configured to control the mobile drone station by using a commercial wireless network;
a remote pilot center configured to set a drone navigation plan to a local authority of a drone traffic management authority; and
an edge computing system configured to analyze images taken by the drone in a real time.

2. The drone communication and control system of claim 1, wherein the drone navigation plan includes a flight routing, an altitude and a flying time.

3. The drone communication and control system of claim 1, wherein the remote pilot center configured to maintain a mobile drone station within a distance from the drone within a visible line of sight.
